(19) United States
(12) Patent Application Publication
(10) Pub. No.: US 2009/0038350 A1
(43) Pub. Date: Feb. 12, 2009

(54) Locking Mechanism For An Image Forming Device

(76) Inventors: Jason Lee Rowe, Richmond, KY (US); Thom Jer Bacalso, Cebu City (PH); Rommel Cabanet Balala, Lapu-Lapu City (PH)

Correspondence Address: John J. McArdle, Jr.;Lexmark International, Inc., Intellectual Property Department, 740 West New Circle Road, Lexington, KY, 40550, US

(21) Appl. No.: 11/834,747

(22) Filed: Aug. 7, 2007

(51) Int. Cl. E05B 65/00

(52) U.S. Cl. 70/57; 414/800

(57) ABSTRACT

The present application is directed to methods and devices for a locking mechanism to connect input components for use within an image forming device. Two or more input components are placed in a stacked arrangement. The locking mechanism of a first input component engages the locking mechanism of a second input component to connect the input components. The locking mechanism may be activated automatically when the input units are stacked.

### BACKGROUND

The present application relates generally to image forming devices, and, more specifically, to methods and devices for automatically locking multiple input sources together.

Image forming devices move media sheets along a media path. The media sheets initially begin at an input area that is sized to hold a stack of sheets. Each sheet is picked from the stack and introduced into the media path. The media path comprises a series of roller nips, guides, and/or belts. The sheets move along the media path and through an imaging area where an image is transferred to the sheet. The media sheet is then either output from the device, or re-circulated through a duplex path for receiving an image on a second side.

Image forming devices may include multiple input sources to introduce the media sheets into the media path. The input sources may accommodate a variety of media types, and a range of media sheet quantities from a single media sheet to large quantities such as 2,000+ sheets. The image forming device typically includes at least one input source integrated into the structure of the device, such as removable tray that is configured to hold a stack of media sheets The image forming device may also include a multipurpose feeder for transparencies, envelopes, card stock, and the like.

Image forming devices may also have the capability to add additional input sources to the device. These additional input sources may take the form of a module having generally the same length and width as the image forming device that connect to a bottom surface of the device. One or more additional input sources may be stacked together to provide the desired media selection. In addition, a base unit may be attached below the additional input sources. In order to maintain structural stability and to avoid tipping of the assembled image forming device and input sources, a locking mechanism may be used to connect one or more of the individual units.

### SUMMARY

The present application is directed to methods and devices for a locking mechanism to connect input components for use within an image forming device. Two or more input components are placed in a stacked arrangement. The locking mechanism of a first input component engages the locking mechanism of a second input component to connect the input components The locking mechanism may be activated automatically when the input units are stacked.

### BRIEF DESCRIPTION OF THE DRAWINGS

FIG. 1 is a schematic view of an image forming device according to one embodiment.

FIG. 2 is a schematic view of an image forming device with multiple media input units according to one embodiment.

FIG. 3 is a perspective view of a locking mechanism according to one embodiment.

FIG. 4 is a front view of a locking mechanism according to one embodiment.

FIG. 5 is a side view of a locking mechanism according to one embodiment.

FIG. 6 is an exploded perspective view of two media input units and a base unit according to one embodiment.

FIG. 7 is a perspective view of a portion of a locking mechanism according to one embodiment.

FIG. 8 is a perspective view of a portion of a locking mechanism according to one embodiment.

### DETAILED DESCRIPTION

The present application is directed to methods and devices for a locking mechanism to connect input components for use within an image forming device. Two or more input components are placed in a stacked arrangement. In addition, the image forming device may be stacked on top of the input components. The locking mechanism of a first input component engages the locking mechanism of a second input component to connect the input components. The locking mechanism may be activated automatically when the input units are stacked.

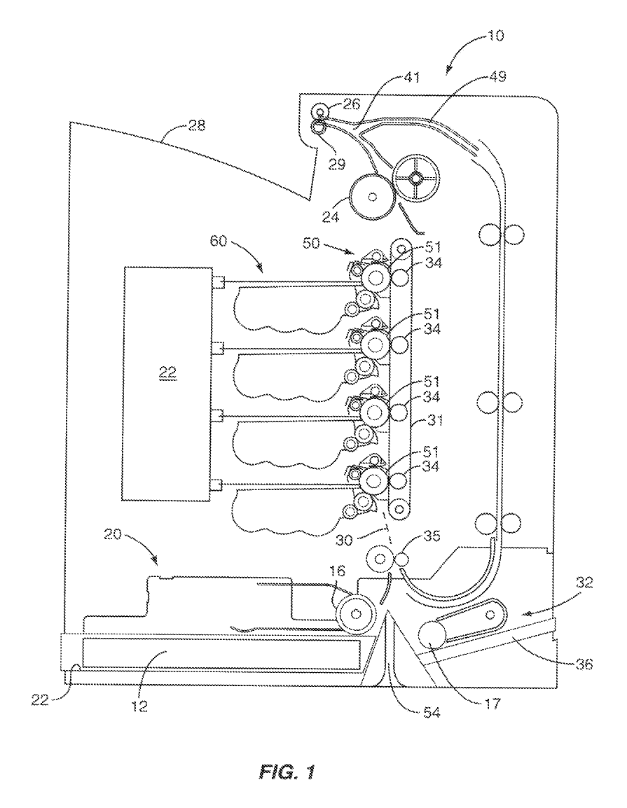

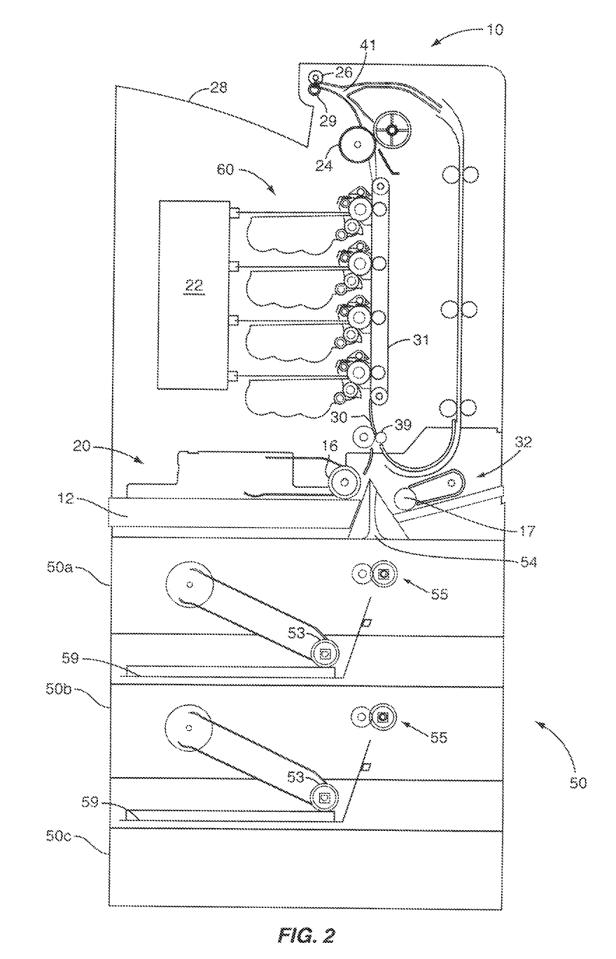

The locking mechanism will be better understood in the context of the image forming device illustrated in FIGS. 1 and 2. FIG. 1 illustrates a representative image forming device 10. A primary input area 20 includes an input tray 22 to receive a stack of media sheets 12. A contact roller 16 may be positioned adjacent to the input tray 22 to contact and introduce the media sheets 12 into a media path 30. The input area 20 may also include a multipurpose feeder 32. The multipurpose feeder 32 may include a support surface 36 to support one or more media sheets 12, and a contact roller 17 to contact and move the media sheets 12 into a media path 30.

Media sheets 12 are moved from the input area 20 and fed into the media path 30. One or more registration rollers 35 align the media sheets 12 and precisely control its further movement along the media path 30. A media transport belt 31 forms a section of the media path 30 for moving the media sheets 12 past a plurality of image forming units 60. Color printers typically include four image forming units 60 for printing with cyan, magenta, yellow, and black toner to produce a four-color image on the media sheet 12.

An imaging device 22 forms an electrical charge on a photoconductive member within the image forming units 60 as part of the image formation process. The media sheet 12 with loose toner is then moved through a fuser 24 that adheres the toner to the media sheet 12. An exit roll 26 forming a nip with a nip roll 29 is positioned at an output area. The exit roll 26 rotates in a forward direction to expel the media sheet 12 from the device 10 and out to an output tray 28. Alternatively, the exit roll 26 may rotate in a forward direction for a limited time until a trailing edge of the media sheet 12 passes an intersection point 41 along the media path 30. The exit roll 26 is then rotated in a reverse direction to drive the media sheet 12 into a duplex path 49. The duplex path 49 directs the inverted media sheet 12 back through the image formation process for forming an image on a second side of the media sheet 12.

FIG. 2 illustrates the image forming device of FIG. 1 including several input components 50. In this embodiment, a first input component 50a and a second input component 50b function as media handling units and feed media sheets 12 to the image forming device 10. Although two media handling input components 50a, 50b are illustrated, it is understood to those skilled in the art that more than two media handling input components 50a, 50b may be combined, and that each may handle a different type of media. For example, input component 50a may handle 8½″×11″ plain paper, and input component 50b may handle 8½″×14″ paper. Each of the input components 50a, 50b may include a pick mechanism 53 that picks sheets from input area 59. In one embodiment, the input area 59 is a tray and has a larger capacity than the primary input source 20 to hold a greater number of sheets. Feed rollers 55 are located downstream from the pick mechanism 53 to receive the sheets and forward them through an input path 54 towards the media path 30.

In addition to media handling units, the input components 50 may serve other functions such as a storage area, a base unit to increase the overall height of the image forming device, or a base unit with castors or wheels to facilitate relocation of the image forming device. FIG. 2 illustrates a third input component in the form of a base unit 50c below the second input component 50b.

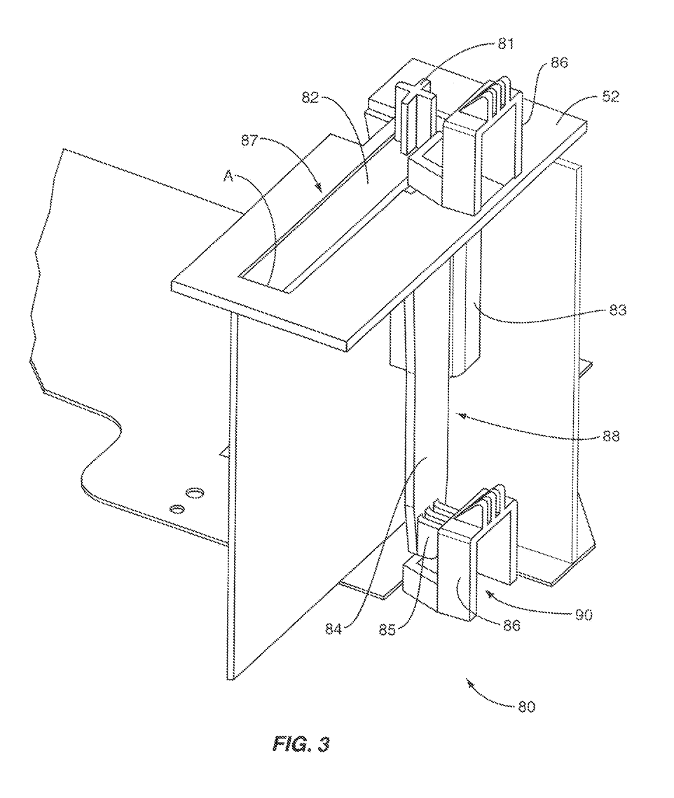

FIG. 3 illustrates the positioning of the elements of one embodiment of the locking mechanism 80 when two input components 50a, 50b are placed in a stacked arrangement as illustrated in FIG. 2. In this embodiment, the locking mechanism 80 includes a cam mechanism positioned within the first input component 50a and a receiver 86 positioned on an upper surface 52 of the second input component 50b. Note that FIG. 3 also illustrates a second receiver 86 located in the upper portion of the figure and positioned on the upper surface 52 of the first input component 50a. The second receiver 86 would be used if another input component 50 (not shown) were stacked on the first input component 50a.

The cam mechanism includes a hook activator 87 and a hook arm 88. The hook activator 87 includes a top arm 82 and a lower arm 83. The top arm 82 is biased in a position generally parallel to and flush with the upper surface 52 of the input component 50a. In one embodiment, the hook activator 87 is integrally formed with the upper surface 52. The hook activator 87 and the upper surface 52 may be constructed of a resilient material which biases the hook activator 87 in the position flush with the upper surface 52. In another embodiment, a spring (not shown) maintains the hook activator 87 in the biased position, although other biasing structures and/or components know in the art are also contemplated. A first end of the top arm is pivotably attached to the upper surface 52 at point A. Extending upward in relation to the upper surface 52 from an opposite end of the top arm 82 from point A is a contact button 81. The lower arm 83 extends downward in relation to the top surface 52 from the end of the top arm 82 that includes the contact button 81. Thus, the top arm 82 and the lower arm 83 form an L-shape. When a force is applied to the contact button 81, the hook activator 87 pivots in a first direction about point A as illustrated in FIG. 4.

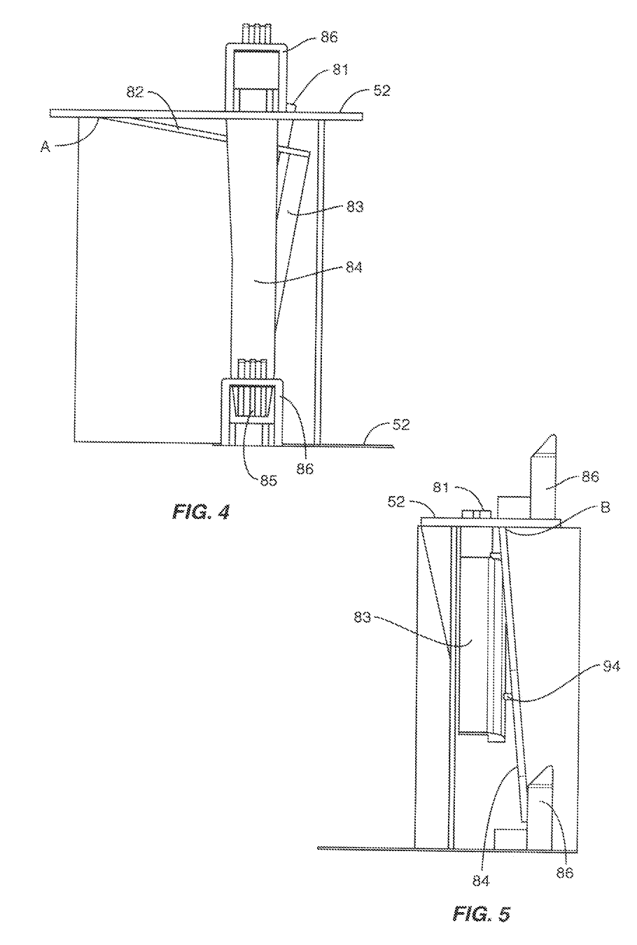

A top end of the hook arm 88 as illustrated in FIG. 5 is pivotably attached to the upper surface 52 at point B. An arm portion 84 of the hook arm 88 extends downward from the upper surface 52. Prior to the locking mechanism 80 being activated, the arm portion 84 is generally parallel to the lower arm 83 of the hook activator 87. Located at a lower end of the arm portion 84 is a hook member 85. The hook member 85 extends essentially outward from the arm portion 84. A tab 94 extends outward from a side of the arm portion opposite that of the hook member 85. The tab 94 extends outward a distance sufficient to extend into the pivot path of the hook activator 87. When the hook activator 87 pivots, the lower arm 83 makes contact with the tab 94 of the hook arm 88. This contact causes the hook arm 88 to pivot about point B in a second direction as illustrated in FIG. 5, the second direction being generally perpendicular to the first direction of the hook activator 87 The pivoting movement of the hook arm 88 moves the hook member 85 laterally outward.

Similar to the previous discussion of the hook activator 87, the hook arm 88 may also be integrally formed with the upper surface 52 (or another part of the input component 50). The hook arm 88 and the upper surface 52 may be constructed of a resilient material which may bias the hook arm 88 in an unlocked position as shown in FIG. 3. In another embodiment, a spring (not shown) maintains the hook arm 88 in the unlocked position although other biasing structures and/or components know in the art are also contemplated.

The receiver 86 is located on the top surface 52 of each input unit 50. In one embodiment, the receiver 86 has an inverted U-shape and extends upward from the upper surface 52 defining an open space 90 within the U-shape. When the first input source 50a is stacked on top of the second input source 50b, the hook member 85 of the first input source 50a aligns with the receiver 86 of the second input source 50b. The receiver is positioned such that the open space 90 is oriented toward the hook member 85. As the hook member 85 extends laterally outward, the hook member 85 moves into the open space 90 and engages the receiver 86. The engagement of the hook member 85 and the receiver 86 lock the first input source 50a and the second input source 50b together.

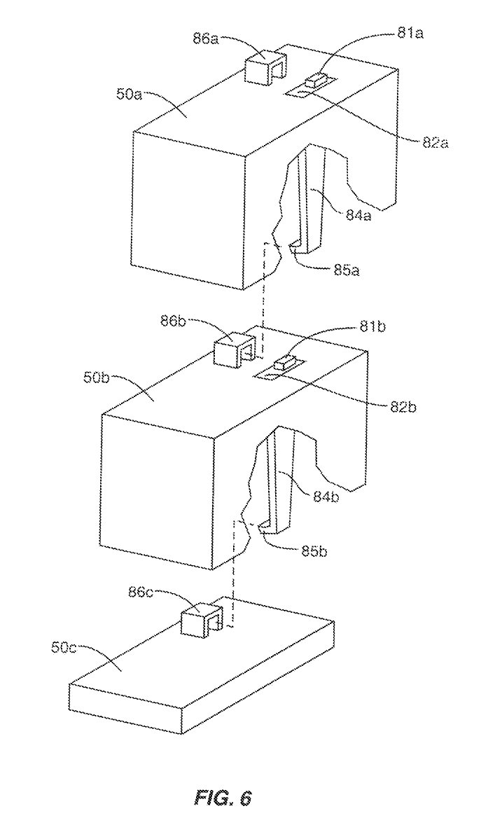

As illustrated in FIG. 6, the receiver 86 may be positioned on an upper surface of an input component 50c that is not a media handling unit, such as the storage and base units described above. These base unit input components 50c are typically the last unit (i.e., the vertically lowest component) in the stack. Thus, they do not include the cam mechanism illustrated in FIG. 3. The cam mechanism of the input component 50b engages the receiver 86 on the base unit input component 50c, further locking the input components 50a-c into a unified structure.

Operation of an embodiment of the locking mechanism 80 for an image forming device 10 including a base unit 50c and two input components 50a, 50b is illustrated in FIG. 6. The base unit 70 is first placed on a support surface such as a floor or a table. Extending upward from an upper surface of the base unit 50c is the receiver 86c. Next, the second input source 50b is placed on top of the base unit 50c. The arm portion 84b and hook member 85b of the second input component 50b are aligned with the receiver 86c of the base unit 50c. In this alignment, the hook member 85b is positioned in front of the open space 90 of the receiver 86c, but is not yet engaged with the receiver 86c. At this point, the second input unit 50b and the base unit 50c are not locked together.

The first input component 50a is then placed on top of the second input component 50b As the two input components 50a, 50b are joined, a lower surface of the first input component 50a makes contact with the contact button 81b of the second input component 50b. The top arm 82b pivots downward causing the lower arm 83b (not shown in FIG. 6) to contact the arm portion 84b. The arm portion 84b then pivots, moving the hook member 85b into the open space 90 of the receiver 86c. At this point, the second input component 50b and the base unit 50c are locked together.

Next, the image forming device 10 (not shown in FIG. 6) is placed on top of the first input component 50a. A bottom surface of the image forming device 10 makes contact with the contact button 81a of the first input component 50a. The top arm 82a pivots downward causing the lower arm 83a (not shown in FIG. 6) to contact the arm portion 84a. The arm portion 84a then pivots, moving the hook member 85b into the open space 90 of the receiver 86b. At this point, the first input component 50a, the second input component 50b, and the base unit 50c are all locked together forming a unified structure.

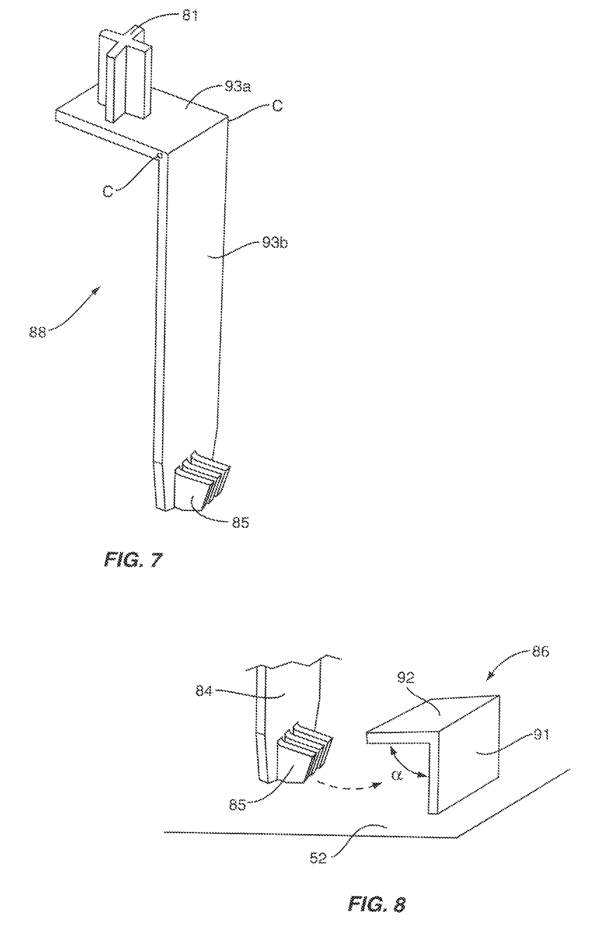

An alternate embodiment of a portion of the locking mechanism 80 is illustrated in FIG. 7. In this embodiment, the hook activator and hook arm are combined into a single hook arm 88. The hook arm 88 includes a first arm 93a with a second arm 93b extending essentially perpendicular from a first end of the first arm 93a, forming an L-shape. A contact button 81 is connected adjacent to a second end of the first arm 93a, extending upward in a generally opposite direction from the second arm 93b. Attached to an end of the second arm 93b opposite from the first arm 93a is a hook member 85. The hook member 85 extends essentially perpendicularly outward from the second arm 84b in a direction opposite that of the first arm 84a.

The hook arm 88 is pivotably connected to the upper surface 52 of the input component 50 at points C. Operation of the embodiment illustrated in FIG. 7 is similar to that described above. The contact button 81 extends upward form the top surface 52 of the input component 50. The contact button 81 is pressed downward causing the hook arm 88 to pivot about points C. As the hook arm 88 pivots, the hook member 85 moves laterally outward and engages a receiver 86.

FIG. 8 illustrates an embodiment of the receiver 86 including a side wall 91 extending upward from the upper surface 52 of the input component 50. Extending at an angle a from a top edge of the side wall 91 is a top wall 92. In one embodiment, the angle α is less than or equal to 90 degrees. The receiver 86 is oriented such that the side wall 91 is generally parallel to the arm portion 84 of the hook arm 88, and the top wall 92 extends generally towards the arm portion 84. In this orientation, as the hook arm 88 pivots as shown by the arrow in FIG. 8, the hook member 85 engages an underside of the top wall 92.

Spatially relative terms such as “under”, “below”, “lower”, “over”, “upper”, and the like, are used for ease of description to explain the positioning of one element relative to a second element. These terms are intended to encompass different orientations of the device in addition to different orientations than those depicted in the figures. Further, terms such as “first”, “second”, and the like, are also used to describe various elements, regions, sections, etc. and are also not intended to be limiting. Like terms refer to like elements throughout the description.

As used herein, the terms “having”, “containing”, “including”, “comprising”, and the like are open ended terms that indicate the presence of stated elements or features, but do not preclude additional elements or features. The articles “a”, “an” and “the” are intended to include the plural as well as the singular, unless the context clearly indicates otherwise.

The present invention may be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

What is claimed is:

1. A locking mechanism for connecting a first input component and a second input component for use with an image forming device, the locking mechanism comprising:
a tray within the first input component sized to receive a stack of media sheets;
an arm attached to the first input component, the arm movable from a first position to a second position;
a contact button attached to the arm and positioned to extend above the tray of the first input component;
a hook adapted to move between unlocked and locked positions; and
a receiver attached to the second input component, and positioned in proximity to the hook when the first input component is stacked onto the second input component;
movement of the arm from the first position to the second position causes the hook to move from the unlocked position that is spaced away from the receiver to the locked position that engages the receiver to prevent relative movement between the stacked first and second input components.

2. The locking mechanism of claim 1, wherein the hook is connected to a first end of the arm and the contact button is connected to the arm in proximity to a second end of the arm.

3. The locking mechanism of claim 2, wherein the arm moves from the first position to the second position in response to a force applied to the contact button.

4. The locking mechanism of claim 3, wherein the arm is pivotably attached to the first input component, and the arm pivots from the first position to the second position.

5. The locking member of claim 1, wherein the first input component includes a support surface for receiving the image forming device, and the contact button extends above the support surface.

6. The locking mechanism of claim 1, wherein the second end of the arm is positioned in proximity to an upper surface of the first input component and the first end of the arm is positioned in proximity to a lower surface of the first input component.

7. The locking mechanism of claim 1, wherein the receiver includes an opening configured to accept the hook therein.

8. A locking mechanism for connecting a first input component and a second input component for use with an image forming device, the locking mechanism comprising:
a tray within the first input component sized to receive a stack of media sheets;
a first arm connected to the first input component, the first arm moveable along a first path from a first position to a second position;
a second arm connected at a first end to the first input component, the second arm moveable along a second path from a first position to a second position;
a contact button connected to the arm in proximity to a first end of the first arm and positioned to extend above the tray of the first input component;
a hook connected to a second end of the second arm, and adapted to move between unlocked and locked positions; and
a receiver attached to the second input component, and positioned in proximity to the hook when the first input component is stacked onto the second input component;
movement of the second arm to the second position in response to movement of the first arm to the second position causes the hook to move from the unlocked position that is spaced away from the receiver to the locked position that engages the receiver to prevent relative movement between the stacked first and second input components.

9. The locking mechanism of claim 8 wherein the first arm moves from the first position to the second position in response to a force applied to the contact button.

10. The locking mechanism of claim 8 wherein at least a portion of the second arm is positioned within the first path when the second arm is in the first position.

11. The locking mechanism of claim 10 wherein a second end of the first arm contacts the second arm when the first arm moves from the first position to the second position.

12. The locking mechanism of claim 11 wherein the contact between the first arm and the second arm causes the second arm to move from the first position to the second position.

13. The locking mechanism of claim 12, wherein the first path is generally perpendicular to the second path.

14. The locking mechanism of claim 13, wherein the first and second input components remain in contact when the second input component moves from the first position to the second position.

15. The locking mechanism of claim 9, wherein the hook remains engaged with the receiver as long as the force is applied to the contact button.

16. A method for locking together a first input source and a second input source of an image forming device the method comprising:
stacking the first input component including a tray sized to receive a stack of media sheets onto the second input component;
aligning an arm attached to the first input component with a receiver attached to the second input component the arm including a contact button connected to the arm in proximity to a first end of the arm and a hook connected to a second end of the arm; and
contacting the contact button and moving the arm from a first position with the hook in an unlocked position in proximity to the receiver to a second position with the hook in a locked position that engages the receiver and prevents relative movement between the stacked first and second input components.

17. The method of claim 16, wherein contacting the contact button further comprises moving the contact button from a first position spaced apart from the tray to a second position in closer proximity to the tray.

18. The method of claim 17, wherein moving the arm further comprises rotating the arm about a fixed point

19. The method of claim 16 wherein aligning the arm with the receiver further comprises extending the hook generally perpendicular from the arm in a direction aligned with an open space within the receiver.

20. The method of claim 16 further comprising contacting the arm with a second arm and moving the arm from the first position to the second position.
